(19) United States
(12) Patent Application Publication
(10) Pub. No.: US 2019/0080829 A1
(43) Pub. Date: Mar. 14, 2019

(54) MAGNET ARRAY WITH NEAR SINUSOIDAL FIELD OUTPUT

(71) Applicant: Dexter Magnetic Technologies, Inc., Elk Grove Village, IL (US)

(72) Inventors: Bo Zhang, Lake Zurich, IL (US); Christopher A. Ras, St. Charles, IL (US)

(21) Appl. No.: 16/127,747

(22) Filed: Sep. 11, 2018

Related U.S. Application Data
(60) Provisional application No. 62/557,229, filed on Sep. 12, 2017.

(51) Int. Cl. H01F 7/02

(52) U.S. Cl. CPC H01F 7/0278; H01F 7/021

(57) ABSTRACT

A magnetic device includes a hub and a plurality of alternatingly polarized pole magnets disposed on a surface of the hub. A polarization direction of the pole magnets is perpendicular to a surface of the hub. A quadrature magnet is disposed in each space between adjacent pole magnets, wherein a size and shape of the pole magnets and the quadrature magnets are configured such that an amplitude distribution of a magnetic field of the device is substantially sinusoidal with respect to position along the hub.

### CROSS REFERENCE TO A RELATED APPLICATIONS

Priority is claimed from U.S. Provisional Application No. 62/557,229 filed on Sep. 12, 2017, which application is incorporated herein by reference in its entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of magnetic devices used for, for example, coupling motion, generating rotational energy and/or generating electricity from mechanical motion. More specifically, the disclosure relates to structures for a magnetic device having a desired spatial distribution of magnetic field induced by magnets disposed on the device.

Permanent magnet machines such as motors, magnetic couplings and other such devices are widely used for a large number of different purposes. In permanent magnet machines such as rotating magnetic devices, for example, permanent magnets of alternating polarity are fixed to a rotor or stator of the rotating magnetic device to induce a magnetic field which interacts with an electrically induced magnetic field to introduce rotary movement (for permanent magnet motors). In other rotating magnetic devices such as permanent magnet generators, such magnetic field may interact with electrical conductors suitably placed within the permanent magnets' field to generate electricity. FIG. 1A shows an example of a simple rotary magnetic device structure having a circular cross-section hub 12 and alternatingly radially polarized magnets 14, 16 disposed on an outer surface of the hub 12. FIG. 1B shows a graph of amplitude of the magnetic field with respect to rotary orientation of the magnetic device of FIG. 1A with respect to rotary orientation. It may be observed in FIG. 1B that the magnetic field distribution of the device shown in FIG. 1A is sinusoidal but has high order harmonics in the field amplitude. Such high order harmonics contents are undesirable because of effects such as torque ripple, vibration, noise, and low Q-factor of back-electromotive force (EMF).

Halbach magnet arrays are often used for higher magnetic field output and/or farther magnetic field penetration. An example rotating magnetic device structure having a Halbach magnet array is shown in FIG. 2A, wherein the hub 12 has alternatingly radially polarized magnets 14, 16 disposed on the surface of the hub 12. The alternatingly polarized magnets 14, 16 may have a substantially rectangular cross section other than a surface shaped to conform to the surface of the hub 12, thus leaving wedge shaped spaces between the magnets 14, 16 into which quadrature magnets 18 may be shaped to fit and disposed. The quadrature magnets 18 are polarized transversely to the polarization direction of the alternatingly radially polarized magnets 14, 16 and such polarization of the quadrature magnets 18 may also alternate in direction with respect to each other. The quadrature magnets 18 in Halbach such magnet arrays changes the spatial distribution of the magnetic field as may be observed in FIG. 2B. Specifically, the magnetic field amplitude with respect to rotary orientation of a Halbach magnet array as shown in FIG. 2A is not perfectly sinusoidal. A Halbach array magnetic field has even more high order harmonics than the magnetic field of the simple device shown in FIG. 1A with accompanying undesirable effects.

### SUMMARY

A magnetic device according to one aspect of the disclosure includes a hub and a plurality of alternatingly polarized pole magnets disposed on a surface of the hub. A polarization direction of the pole magnets is perpendicular to a surface of the hub. A quadrature magnet disposed in a space between each pair of adjacent pole magnets, wherein a size and shape of the pole magnets and the quadrature magnets are configured such that an amplitude distribution of a magnetic field is substantially sinusoidal with respect to position along the hub.

In some embodiments, the hub has a substantially circular cross-section.

In some embodiments, the pole magnets have a substantially rectangular cross-section apart from a surface of each pole magnet in contact with the hub.

In some embodiments, the quadrature magnets comprise a wedge shape conforming to a shape of a space between adjacent pole magnets.

Some embodiments further comprise a non-magnetic spacer disposed in a part of the space between adjacent pole magnets not occupied by the quadrature magnet.

Some embodiments further comprise an encapsulation on a surface defined by an end of the pole magnets not in contact with the hub.

In some embodiments, the encapsulation comprises an electrically non-conductive non-magnetic material.

In some embodiments, the encapsulation comprises a non-magnetic material having electrical conductivity at most of an amount such that the amplitude distribution of the magnetic field is substantially unaffected by induced eddy current.

### BRIEF DESCRIPTION OF THE DRAWINGS

FIG. 1A shows a simple rotating magnetic device known in the art.

FIG. 1B shows an amplitude of the static magnetic field of the device in FIG. 1A with respect to rotary orientation of the device.

FIG. 2A shows a Halbach magnet arrangement for a rotating magnetic device.

FIG. 2B shows amplitude of the static magnetic field of the device in FIG. 2A with respect to rotary orientation of the device.

FIG. 3A shows an example embodiment of a rotating magnetic device according to the present disclosure

FIG. 3B shows amplitude of the static magnetic field of the device in FIG. 3A with respect to rotary orientation of the device.

FIG. 4 shows an example linear magnet array according to the present disclosure.

### DETAILED DESCRIPTION

FIG. 3A shows an example embodiment of a magnetic device such as a rotary magnetic device 100 according to the present disclosure. The rotary magnetic device 100 may comprise a hub 103 having a substantially circular cross section. The hub 103 may have disposed thereon alternatingly radially polarized pole magnets 101A, 101B similar in configuration to the radially polarized magnets explained with reference to FIG. 2A. In between adjacent pole magnets 101A, 101B, may be disposed alternatingly, circumferentially polarized quadrature magnets 102. The quadrature magnets 102 may have a size chosen so as not to completely fill the space between adjacent pole magnets 101A, 101B. Unfilled space between adjacent pole magnets 101A, 101B, that is, the space not occupied by the quadrature magnets 102 may be filled by a non-magnetic spacer 105.

The hub 103 may be made from of a ferromagnetic material such as steel. In the present example embodiment, the hub 103 may comprise locking features 103A on its surface to provide suitably fixed attachment positions for the quadrature magnets 102. Such features 103A may facilitate assembly of the rotary magnetic device 100 and may provide the rotary magnetic device with more resistance to movement of any of the magnets 101A, 101B, 102 when mechanical force is transmitted through the rotary magnetic device.

In some embodiments, an encapsulation 104 such as may be made from electrically non-conductive or low electric conductivity, and non-magnetic material may be provided for protection of the hub 103 and magnets 101A, 101B, 102 from corrosion. Low conductivity in the present context may mean a conductivity limited to an amount that will not enable induced eddy current large enough to substantially alter the spatial distribution of the magnetic field having properties as further explained below.

The size, shape, and location of the pole magnets 101A, 101B and quadrature magnets 102 on the hub 103 are arranged such that the magnetic field with respect to rotary orientation is nearly fully sinusoidal.

A graph of the static magnetic field amplitude with respect to rotary orientation of the device of FIG. 3A is shown in FIG. 3B, where it may be observed that the magnetic field amplitude distribution more closely matches sinusoidal distribution than the Halbach rotary magnetic device shown in FIG. 2A.

The rotary magnetic device shown in FIG. 3A may be disposed inside a larger diameter device, such as a rotationally fixed stator. In some embodiments, the respective radial positions of the hub 103, the magnets 101A, 101B, 102 and non-magnetic spacers 105 may be reversed such that the rotary magnetic device forms a rotationally fixed stator.

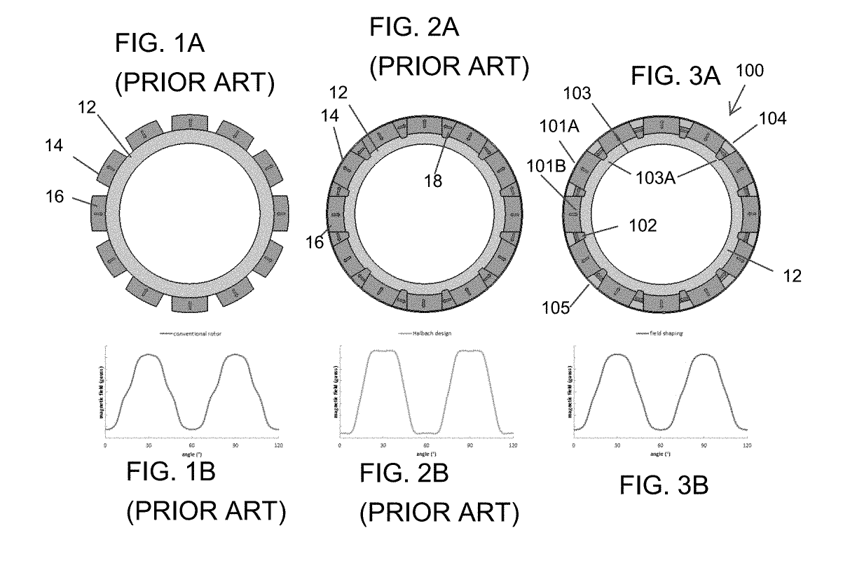

An optimized magnet array for a rotary magnetic device as shown in FIG. 3A may have magnetic field amplitude with much smaller effect of high order harmonics than the magnetic device shown in FIG. 1A and FIG. 2A. To the extent the magnetic field amplitude distribution with respect to rotary orientation closely matches a sinusoidal wave, using a rotary magnetic device such as shown in FIG. 3A may have greatly reduced torque ripple, vibration, noise, and enhanced Q-factor of back-EMF.

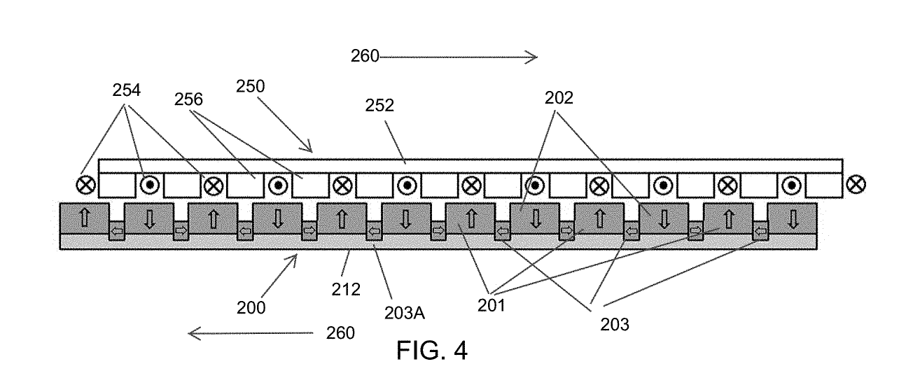

Although the foregoing example embodiment has been shown as and explained as being a component of a rotary magnetic device, those skilled in the art will appreciate that similar design principles may be applied to a linear magnetic device. An example embodiment of a linear magnetic device is shown in FIG. 4. The device may comprise a first component 200 and a second component 250. Either the first component 200 or the second component 250 may be fixed, with the other component enabled to move linearly in a direction along lines indicated by numeral 260. It is only required that the first component 200 be able to move in such direction relative to the second component 250. The first component 200 may comprise a planar form of the hub (103 in FIG. 3A) in the form of an carrier plate 212 such as may be made from steel or other ferromagnetic material. A plurality of first pole magnets 201 may be affixed to the carrier plate 212 at spaced apart locations. The first pole magnets 201 may be polarized transversely to the plane of the carrier plate 212 in one direction. Second pole magnets 202 may be affixed to the carrier plate 212 at spaced apart locations between first pole magnets 201 and polarized in a direction opposite to the first pole magnets 201. In combination, the first pole magnets 201 and the second pole magnets 202 are alternatingly polarized perpendicularly to the plane of the carrier plate 212. Spaces 203A between adjacent first 201 and second 202 pole magnets may comprise recesses 203A in each of which may be disposed a quadrature magnet 203. The quadrature magnets 203 may be alternatingly polarized parallel to the plane of the carrier plate 212. A size and shape of the quadrature magnets 203 may be chosen such that magnetic field amplitude varies substantially sinusoidally with respect to position in the direction indicated by arrows 260. In the present example embodiment, the second component 250 may comprise an electromagnet including a planar form of the hub (103 in FIG. 3A) as an carrier plate 252 similar to the carrier plate 212 of the first component 200, and a plurality of spaced apart ferromagnetic pole shoes 256 disposed along the plane of the carrier plate 252. Spaces may be provided between pole shoes 256 for placement of wire coils 254, shown in alternating winding direction by the symbols ● and X such that electric current passed through the wire coils 254 will induce an alternatingly polarized magnetic field. Such alternatingly polarized magnetic field may induce relative movement between the first component 200 and the second component 250.

Although only a few examples have been described in detail above, those skilled in the art will readily appreciate that many modifications are possible in the examples. Accordingly, all such modifications are intended to be included within the scope of this disclosure as defined in the following claims.

What is claimed is:

1. A magnetic device comprising:
a hub;
a plurality of alternatingly polarized pole magnets disposed on a surface of the hub, a polarization direction of the pole magnets being perpendicular to a surface of the hub; and
a quadrature magnet disposed in each space between adjacent pole magnets, wherein a size and shape of the pole magnets and the quadrature magnets are configured such that an amplitude distribution of a magnetic field is substantially sinusoidal with respect to position along the hub.

2. The device of claim 1 wherein the hub has a substantially circular cross-section.

3. The device of claim 2 wherein the pole magnets have a substantially rectangular cross-section apart from a surface of each pole magnet in contact with the hub.

4. The device of claim 3 wherein the quadrature magnets comprise a wedge shape conforming to a shape of a space between adjacent pole magnets.

5. The device of claim 4 further comprising a non-magnetic spacer disposed in a part of the space between adjacent pole magnets not occupied by the quadrature magnet.

6. The device of claim 1 further comprising an encapsulation on a surface defined by an end of the pole magnets not in contact with the hub.

7. The device of claim 6 wherein the encapsulation comprises an electrically non-conductive non-magnetic material.

8. The device of claim 6 wherein the encapsulation comprises a non-magnetic material having electrical conductivity at most of an amount such that the amplitude distribution of the magnetic field is substantially unaffected by induced eddy current.

9. The device of claim 1 wherein the hub comprises a planar carrier plate.
